(19) United States
(12) Patent Application Publication
(10) Pub. No.: US 2025/0154974 A1
(43) Pub. Date: May 15, 2025

(54) CONNECTING ELEMENT FOR PLATES OR PLATE-SHAPED COMPONENTS, SUCH AS CARDBOARD PLATES, PLASTIC PLATES OR PLASTIC MULTI-WALL PLATES OR THE LIKE

(71) Applicant: Ernst Kraemer & Söhne GmbH & Co KG, Tonisvorst (DE)

(72) Inventors: Sascha BROTHUHN, Hattorf Harz (DE); Florian BANSE, Leuna (DE)

(21) Appl. No.: 18/939,782

(22) Filed: Nov. 7, 2024

(30) Foreign Application Priority Data
Nov. 10, 2023 (DE) 202023106604.6

(51) Int. Cl. F16B 5/06; F16B 21/02

(52) U.S. Cl. CPC F16B 5/0642; F16B 21/02; F16B 2005/0671

(57) ABSTRACT

A connecting element for cardboard sheets comprises a tubular center, a handle and spaced a locking region. The handle projects radially over the cross section of the center and forms a radial projection. The locking region comprises radially projecting a tab having a wedge-shaped latching element. The connecting element is rotatable between an insertion position and a locking position to connect two sheets. The tab has an edge facing the locking direction and the tab adjacent to the edge is configured as an insertion surface aligned opposite the handle that forms an insertion region of a height H with the corresponding part of the handle. The height H is greater than the distance A between the handle and the locking region in the receiving region, and the height H of the insertion region decreases from the edge toward the receiving region.

The invention relates to a connecting element for plates or components configured in plate or sheet shape, such as cardboard sheets, plastic sheets, plastic panels, or the like, comprising a preferably center section configured in tubular shape, a handle area, as well as a locking area, wherein the handle area and the locking area are spaced from each other at a distance A forming a receiving region; the handle area projects at least in part and preferably fully radially over the cross section Q of the center section forming a radial projection, and the locking area comprises at least one tab that projects radially over the cross section Q of the center section, and wherein the radial projection features at least one locking element preferably configured in wedge shape on its side facing the locking area, and the connecting element can be rotated around the center section in locking direction from its insertion position into its locking position to produce a connection between two sheets to be connected or at least two components configured in sheet shape that are to be connected and can be rotated around the center section in release direction, that is, against the locking direction, from its locking position into its insertion position to release a connection between at least two connected sheets or at least two connected components configured in sheet shape.

The previously described connecting elements serve, for example, for closing cardboard boxes, such as cardboard packaging, moving boxes, or the like. The components configured in sheet shape are, for example, the foldable cardboard surfaces of a cardboard box that form the box lid. If the components configured in sheet shape are, for example, two lid regions which are to be connected to each other and are arranged on two mutually opposite edges of a cardboard box, it frequently occurs that the two lid regions do not rest fully one on top of the other. This makes the rotation of the connecting element in locking direction at least more difficult, in some instances even preventing it.

It is an object of the invention to avoid the aforementioned disadvantages and disclose a connecting element that enables a rotation of the locking element in locking direction even if the components configured in sheet shape that are to be connected do not yet fully touch or do not fully rest against each other.

This object is achieved in that at least one tab features an edge facing in locking direction, and the section of the tab adjacent to the edge is configured as an insertion surface aligned opposite to, and preferably transversely, to the handle region that forms an insertion region of the height H with the corresponding part of the handle area, wherein the height H is greater than the distance A between the handle area and the locking area, and the height H of the insertion region decreases from the edge toward the receiving region. This configuration also allows a rotation of the connecting element in locking direction if the two components configured in sheet shape do not fully rest against each other. By decreasing the height H of the insertion region from the edge toward the receiving region, and thus to the distance A, the plate-shaped components are increasingly displaced toward one another.

The height H represents the diameter over which the two connected components configured in sheet shape are pressed against each other in locking position. The height H can be 8 mm, 14 mm, 15 mm, 21 mm, 22 mm, or 26 mm. Any height H between 1 mm and 40 mm is basically possible, depending on the thickness of the two sheet-shaped components that are to be connected.

The connecting element can be configured in one or more parts. The connecting element can be made, for example, of plastic, preferably polystyrene, polyethylene, polyamide, and/or polypropylene. The connecting element can, of course, also be made, for example, from a regranulate, that is, a recycled material, or a biobased plastic or a mixture of biobased plastics. Other suitable materials can also be used. If the center section is configured in tubular shape, it is a hollow part. The distance A between the handle area and the locking region corresponds to at least the thickness of the sheets to be connected, or to the thickness of the components configured in sheet shape in the area that is to be connected. The distance A is preferably somewhat greater than the thickness of the sheets to be connected or the thickness of the components configured in sheet shape in the area that is to be connected.

In the area of the radial projection toward the center section, on the side facing the locking area, the handle area has at least one preferably latching element configured in wedge shape. The sheet facing the locking area or the component configured in sheet shape that faces the locking area has a corresponding recess, into which the latching element engages when it is in its locking position.

At the same time, in at least one tab, the height H of the insertion region can continuously decrease from the edge to the receiving region.

It is useful if the angle β between the insertion surface and the corresponding area of the handle area, in at least one tab, is between 20° and 40°, preferably 30°.

It is also useful if the transition from the edge facing in locking direction into the adjacent front edge of the tab is configured as rounded or beveled in at least one tab. This prevents the connecting element from being caught in the transition, for example, in a soft cardboard sheet, during rotation in locking direction.

The radial projection can also have at least one clamping element on its side that faces the locking region, wherein the clamping element has a surface that faces in locking direction, a surface that faces in release direction, and a rounded transition region that connects both surfaces. The surface facing in release direction impedes an unintended rotation, since force must be applied for a rotation in release direction, so that the surface facing in release direction can be moved over the adjacent edge of the opening. The convexly rounded transition region allows the clamping element to glide over the adjacent component without damaging it when it is rotated in locking direction and in release direction.

The surfaces facing in locking direction and/or in release direction can preferably be configured with a convex curvature. If the surface facing in release direction is configured with a convex curvature, a greater force must be applied to start and perform the rotational movement, so that the surface facing in release direction can glide over the adjacent edge of the opening.

The surface facing in locking direction, the surface facing in release direction, and the transition area can, at the same time, form a convexly curved total surface.

The total surface can rest on a circular segment having a radius of between 5 mm and 26 mm, preferably between 10 mm and 15 mm.

The clamping element can have, at the same time, a height h of between 2 mm and 8 mm, preferably between 4 mm and 5 mm.

The surface facing in locking direction and/or in release direction and/or the transition area can be formed by at least two webs, preferably arranged respectively in parallel.

At the same time, at least one clamping element and at least one latching element can be arranged diametrically opposite on the center section.

Two diametrically opposite tabs can preferably be provided.

The handle area can be arranged at the one end of the center section and the locking region can be arranged at the other opposite end of the center section.

In the area of at least one tab, the locking area can have at least one spring element that acts in the direction of the handle area. In the locking position of the locking element, each spring element acts on the adjacent sheet or on the adjacent component configured in sheet shape. The sheets or the adjacent components configured in sheet shape are pressed thereby against the handle area and additionally fix the connecting element in its locking position. Each spring element essentially has an axial spring effect relative to the center section.

The handle area can have a preferably internal grip bar.

The outer contour of the handle area can be configured in circular shape.

The handle area can be configured as a grip plate.

At the same time, at least one tab can have a reinforcement rib, preferably configured in one piece with the tab. The tab is reinforced by means of the reinforcement rib and is thus configured more stably, so that it can no longer be broken off as a result of forces occurring during locking and unlocking and during transport. Provided the reinforcement rib is configured as one piece with the tab, the reinforcement rib and the tab are made of the same material and cannot be separated. Such a configuration can be produced, for example, by means of injection molding.

In at least one tab, a reinforcement rib can be arranged on the side of the tab that faces away from the handle area. In such an embodiment, the reinforcement rib does not prevent the locking procedure, since the tab can be configured precisely on the side facing the handle area. If a tab is bent somewhat away from the handle area when the connecting element is rotated in locking direction, from its insertion position into its locking position, and the distance A is thus enlarged, the tab concerned is supported by its assigned reinforcement rib(s). In this case, pressure is applied to each reinforcement rib.

At least one reinforcement rib can be formed as continuous.

As an alternative, at least one reinforcement rib can consist of sections arranged preferably in alignment, one behind the other.

It is practical if at least one reinforcement rib is provided, said rib extending over both tabs as well as over the cross section Q of the center section located between them. In such an embodiment, not only the tab per se, but also the transition region between a tab and the center section, are reinforced.

The invention also relates to a system comprising, on the one hand, at least two sheets to be connected, or at least two components configured in sheet shape that are to be connected, such as cardboard sheets, plastic sheets, or plastic panels, or the like and, on the other hand, at least one connecting element with the previously described configuration, wherein the sheets to be connected or the components configured in sheet shape that are to be connected have at least a respectively aligned opening that is adapted to the contour of the locking region, and a connecting element is guided through the aligned openings in the sheets to be connected or the components configured in sheet shape to be connected in order to connect at least two sheets or at least two components configured in sheet shape until the handle area comes in contact with the handle area of the adjacent sheet that is to be connected or the handle area of the adjacent component configured in sheet shape that is to be connected, and the connecting element can subsequently be rotated in locking direction from its insertion position into its locking position, and can later be rotated to release a connection between the connected sheets or the components configured in sheet shape by rotating it in release direction from its locking position into its insertion position.

Exemplary embodiments of the invention will be described in more detail below with reference to the drawings, wherein:

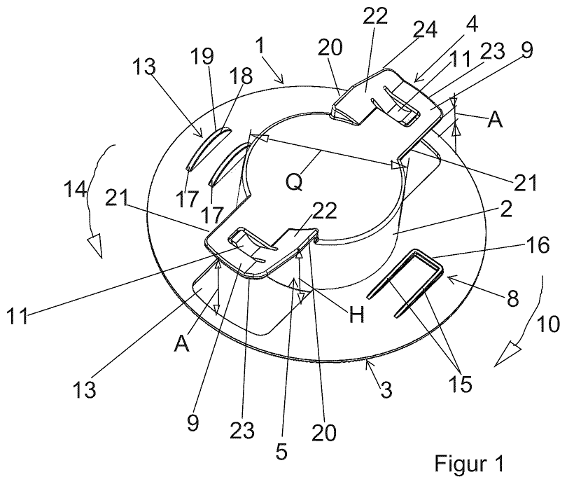

FIG. 1 shows an exemplary embodiment of a connecting element according to the invention,

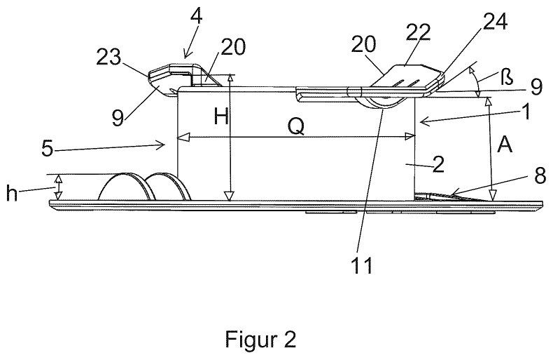

FIG. 2 shows a lateral view of the object according to FIG. 1,

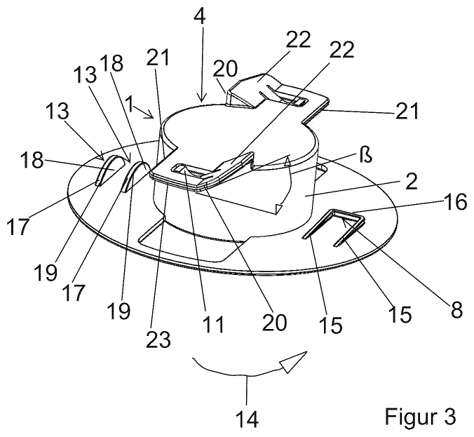

FIG. 3 shows an inclined plan view of the object according to FIG. 1,

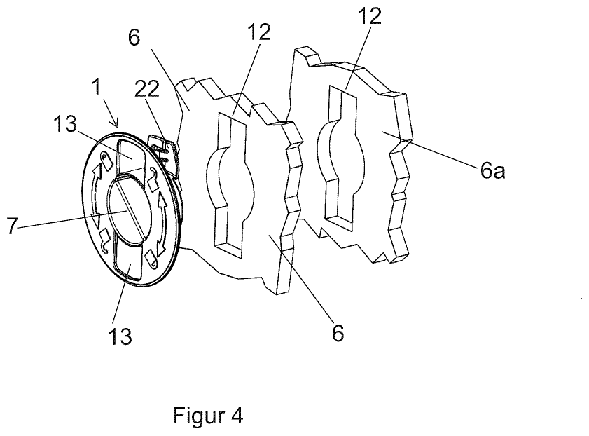

FIG. 4 shows an exploded view of two components configured in sheet shape that are to be connected and a connecting element before installation of the latter,

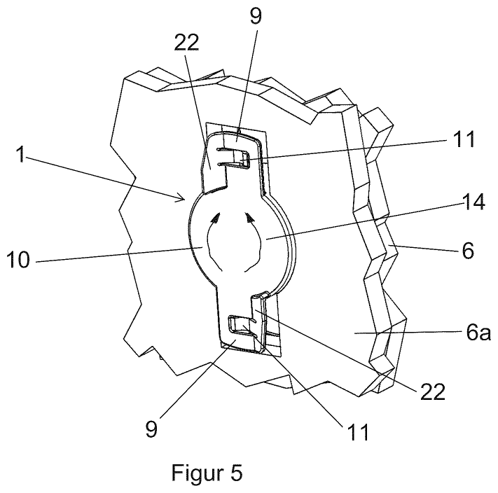

FIG. 5 shows a rear view of the object according to FIG. 4 with the components laid on top of each other, wherein the connecting element has already been inserted and is still in its insertion position,

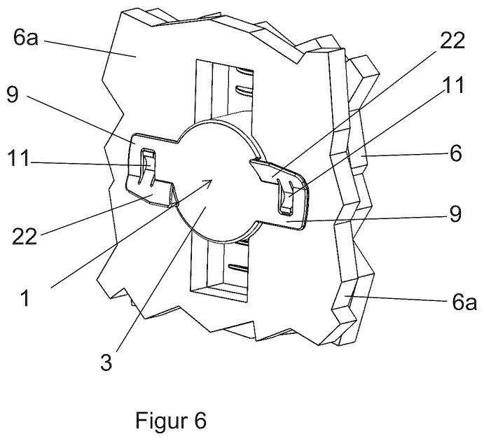

FIG. 6 shows a rear view of the object according to FIG. 5, wherein the connecting element is located in its locking position, und

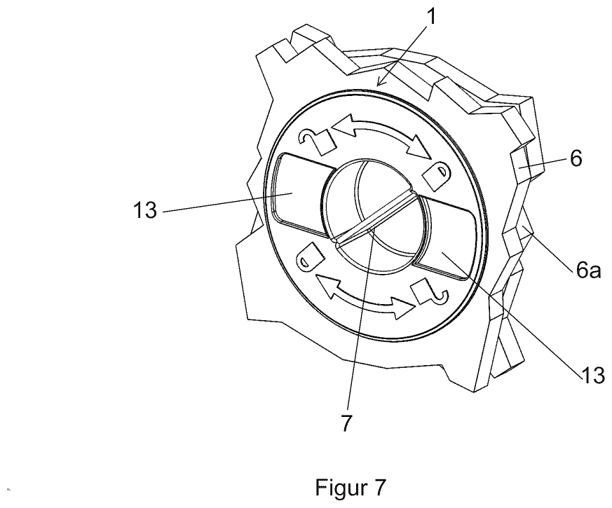

FIG. 7 shows a frontal view of the object according to FIG. 6.

Identical or similar components are identified with corresponding reference signs in all the figures.

FIGS. 1 to 3 show an exemplary embodiment of a connecting element 1 according to the invention. The connecting element 1 according to the invention features a center section 2, which is tubular in the depicted embodiments and is configured as a hollow body and also has a round cross section Q. The center section 2 is configured closed in the region of the end that faces upward in FIG. 1.

The connecting element 1 has a handle area 3 as well as a locking area 4, wherein the handle area 3 is arranged at the one end of the center section 2 and the locking area 4 is arranged at the other, opposite end of the center section 2. The handle area 3 and the locking area 4 are spaced from each other at a distance A, forming a receiving area 5, for example, for receiving components 6, 6a configured in sheet shape.

In the depicted exemplary embodiment, the handle area 3 is located completely radially over the cross section Q of the center section 2. The outer contour of the handle area 3 has a circular configuration. In the depicted exemplary embodiment, the handle area 3 is configured as a grip plate having an internal grip bar 7.

The handle area 3 features a latching element 8 on the side facing the locking area 4. The latching element 8 is arranged here in the area of the radial projection toward the center section 2. As can be seen, for example, in FIG. 1, the latching element 8 is wedge-shaped. The latching element 8 has a sliding surface 15 formed by two webs and a latching surface 16. The sliding surface 15 is oriented transversely to the plane spanned by the handle area 3 on the side facing the locking area 4, while the latching surface 16 is oriented orthogonally to the plane spanned by the handle area 3 on the side facing the locking area 4.

The locking area 4 features two tabs 9 that radially project over the cross section Q of the center section 2. The tabs 9 are arranged rotated by 90° with respect to the latching element 8. Each tab 9 can have one or several reinforcement ribs (which are not shown) on the side facing away from the handle area 3. As can be seen in FIG. 1, each tab 9 has a spring element 11 that acts in the direction of the handle area 3.

The connecting element 1 further has two clamping elements 13 on its side that faces the locking area 4. Each clamping element 13 has a height h of, for example, about 4.5 mm. The clamping elements 13 and the latching element 8 are arranged diametrically opposite relative to the center section 2 in the depicted exemplary embodiments.

Each clamping element 13 has a surface 17 facing in locking direction 14, a surface 18 facing in release direction 10, and a convex rounded transition region 19 that connects the surface 17 and the surface 18.

As can be seen in FIG. 1, each tab 9 has an edge 20 facing in locking direction 14, an edge 21 facing opposite the locking direction 14, as well as a front edge 23. The edge 20 and the edge 21 are parallel. The front edge 23 is orthogonal thereto, so that each tab 9 has an approximately rectangular contour in plan view. In both tabs 9, the section of the tab 9 that is adjacent to the edge 20 is configured as an insertion surface 22 aligned opposite to the handle area 3. Each insertion surface 22 is transversely aligned in the depicted exemplary embodiment. The insertion surface 22 forms an insertion region of the height H with the corresponding area of the handle area 3, wherein the height H is greater than the distance A between the handle area 3 and the locking area 4 in the receiving region. The height H of the insertion region decreases continuously from the edge 20 toward the receiving region 5. The angle β between the insertion surface 22 and the corresponding area of the handle area 3 is about 30° between the insertion surface 22 and the corresponding region of the handle area 3.

In the depicted exemplary embodiments, the transition 24 from the edge 20 facing in locking direction 14 to the adjacent front edge 23 has a beveled configuration in both tabs 9.

FIGS. 4 to 7 show the connecting element 1 according to the invention as well as the system according to the invention. In the depicted exemplary embodiment, two components 6, 6a configured in sheet shape are to be connected to each other. These are here, for example, two lid sections of a cardboard box. As can be seen in FIG. 4, an opening 12 is provided in each component 6, 6a configured in sheet shape. The two openings 12 are aligned when the two components are superimposed. The shape of each opening 12 is adapted to the shape of the center section 2 having the two molded tabs 9 of the connecting element 1.

After the components 6, 6a configured in sheet shape which are to be connected have been superimposed, a connecting element 1 is guided with its locking region 4 through the openings 12 (FIG. 5). By means of a subsequent rotation of the connecting element 1 by 90° in locking direction 14, the connecting element 1 is moved from its insertion position depicted in FIG. 5 into its locking position. This locking position is depicted in FIGS. 6 and 7.

With the rotation of the connecting element 1 in locking direction 14 for the purpose of locking, the sliding surface 15 of the latching element, as well as the surface 18 of the clamping element 10, slide over the respectively adjacent edge of the opening 12 in the sheet-shaped component 6. Due to the transversely aligned insertion surface 22, the height H of the insertion region decreases from the edge 20 toward the receiving region 5. This also allows a rotation of the connecting element 1 in locking direction 14 if the two components 6, 6a configured in sheet shape do not yet fully rest against each other. Due to the reduction in height H of the insertion region from the edge 20 toward the receiving region 5, and thus to the distance A, the components 6, 6a configured in sheet shape are increasingly moved toward each other.

If the connecting element 1 has reached its locking position 14 by means of a rotation in locking direction, the latching surface 16 prevents a further rotation of the connecting element 1 in locking direction 14 beyond the locking position, because in the locking position, the latching surface 16 rests on the edge of the opening 12.

In locking position, the latching element 8 and the clamping elements 13 are located in the opening 12. The convex configured surface 18 of each clamping element 10 prevents an unintended, automatic rotation of the connecting element 1 in release direction 10, from its locking position into its insertion position, for example during transport. A force must in fact be applied in order to rotate the connecting element 1 in release direction 10 due to the convexly configured surface 18, so that the convexly configured surface 18 can be moved over the adjacent edge of the opening 12.

The convexly rounded transition region 19 allows the respective clamping element 13 to slide over the adjacent component 6, 6a without damaging it during a rotation in locking direction 14 and in release direction 10.

For release, the connecting element 1 must simply be rotated back into its insertion position from its locking position, that is, against the locking direction 14 in release direction 10.

In the depicted exemplary embodiments, the handle area 3 has two additional recesses 13. When the connecting element 1 is inserted into the openings 12 of two superimposed sheet-shaped components 6, 6a, a tab 9 is visible through each recess 13. If, however, the connecting element 1 is in its locking position, the component 6 configured in sheet shape, with which the handle area 3 is in contact, is visible through each recess 13.

1. A connecting element (1) for sheets or components (6, 6a) configured in sheet shape, such as cardboard sheets, plastic sheets, or plastic panels or the like, comprising a center section (2) preferably configured in tubular shape, a handle area (3), as well as a locking region (4), wherein the handle area (3) and the locking region (4) are mutually spaced at a distance A forming a receiving region, the handle area (3) projects in part, preferably fully, radially over the cross section Q of the center section (2) forming a radial projection, and the locking region (4) comprises a tab (9) which projects at least radially over the cross section Q of the center section (2), and the radial projection has at least one latching element preferably configured in wedge shape (8) on its side facing the locking region (4), and the connecting element (1) can be rotated from its insertion position into its locking position to make a connection between at least two sheets to be connected or at least two components (6, 6a) configured in sheet shape which are to be connected by means of a rotation around the center section (2) in locking direction (14) and can be rotated out of its locking position into its insertion position to release a connection between at least two connected sheets or at least two connected components (6, 6a) configured in sheet shape by means of a rotation in release direction (10) around the center section (2), wherein at least the tab (9) has an edge (20) facing in locking direction (14) and the section of the tab (9) adjacent to the edge (20) is configured as an insertion surface (22) aligned opposite, preferably transversely, to the handle area (3) that forms an insertion region of the height H with the corresponding part of the handle area (3), wherein the height H is greater than the distance A between the handle area (3) and the locking region (4) in the receiving region and the height H of the insertion region decreases from the edge (20) toward the receiving region.

2. The connecting element (1) according to the claim 1, wherein the height H of the insertion region decreases continuously from the edge (20) to the receiving region in at least one tab (9).

3. The connecting element (1) according to claim 1, wherein the angle β between the insertion surface (22) and the corresponding part of the handle area (3) is between 20° and 40°, preferably 30°, in at least one tab (9).

4. The connecting element (1) according to claim 1, wherein the transition (24) from the edge (20) facing in locking direction (14) to the adjacent front edge (23) of the latch (9) is configured as rounded or beveled in at least one tab (9).

5. The connecting element (1) according to claim 1, wherein the radial projection also has at least one clamping element (13) on its side facing the locking region (4), wherein the clamping element (13) has a surface (17) facing in locking direction (14), a surface (18) facing in release direction (10), and a rounded transition region (19) that connects the surface (17) and the surface (18).

6. The connecting element (1) according to claim 5, wherein the surface (17) and/or the surface (18) is (are) configured with a convex curvature.

7. The connecting element (1) according to claim 5, wherein the surface (17), the surface (18), and the transition region (19) form a convexly curved total surface.

8. The connecting element (1) according to claim 7, wherein the total surface rests on a circular segment having a radius of between 5 mm and 26 mm, preferably between 10 mm and 15 mm.

9. The connecting element (1) according to claim 5, wherein the clamping element (13) has a height h of between 2 mm and 8 mm, preferably between 4 mm and 5 mm.

10. The connecting element (1) according to claim 5, wherein the surface (17) and/or the surface (18) and/or the transition region (19) is (are) respectively formed by means of at least two webs that are preferably arranged in parallel.

11. The connecting element (1) according to claim 5, wherein at least the clamping element (13) and at least one latching element (8) are arranged diametrically opposite relative to the center section (2).

12. The connecting element (1) according to claim 1, wherein two diametrically opposite tabs (9) are provided.

13. The connecting element (1) according to claim 1, wherein the handle area (3) is arranged at one end of the center section (2) and the locking region (4) is arranged at the other, opposite end of the center section (2).

14. The connecting element (1) according to claim 1, wherein the locking region (4) has at least one spring element that acts in the direction of the handle area (3) in the area of at least one tab (9).

15. The connecting element (1) according to claim 1, wherein the handle area (3) has a preferably internal grip bar (7).

16. The connecting element (1) according to claim 1, wherein the outer contour of the handle area (3) is configured in circular shape.

17. The connecting element (1) according to claim 1, wherein the handle area (3) is configured as a grip plate.

18. A system comprising, on the one hand, at least two sheets to be connected or at least two components (6, 6a) configured in sheet shape which are to be connected, such as cardboard sheets, plastic sheets, or plastic panels, or the like and, on the other hand, at least one connecting element (1) according to claim 1, wherein the sheets to be connected or the components (6, 6a) configured in sheet shape which are to be connected, when superimposed, have at least one aligned opening (12), which is adapted to the contour of the locking region (4), and a connecting element (1) is guided through the aligned openings (12) in the sheets to be connected or the components (6, 6a) configured in sheet shape which are to be connected in order to connect at least two sheets or at least two components (6, 6a) configured in sheet shape, until the handle area (3) comes into contact with the sheet adjacent to the handle area (3) or with the component (6, 6a) configured in sheet shape that is adjacent to the handle area (3), and the connecting element can subsequently be rotated from its insertion position into its locking position by means of a rotation in locking direction (14) and can be rotated from its locking position into its insertion position for a later release of a connection between the connected sheets or the connected components (6, 6a) configured in sheet shape by means of a rotation in release direction (10).

19. The connecting element (1) according to claim 2, wherein the angle β between the insertion surface (22) and the corresponding part of the handle area (3) is between 20° and 40°, preferably 30°, in at least one tab (9).

20. The connecting element (1) according to claim 2, wherein the transition (24) from the edge (20) facing in locking direction (14) to the adjacent front edge (23) of the latch (9) is configured as rounded or beveled in at least one tab (9).
